(19) United States
(12) Patent Application Publication
(10) Pub. No.: US 2023/0093438 A1
(43) Pub. Date: Mar. 23, 2023

(54) GLASS SUBSTRATE EMBEDDED PIC TO PIC AND OFF-CHIP PHOTONIC COMMUNICATIONS

(71) Applicant: Intel Corporation, Santa Clara, CA (US)

(72) Inventors: Benjamin DUONG, Chandler, AZ (US); Kristof DARMAWIKARTA, Chandler, AZ (US); Srinivas V. PIETAMBARAM, Chandler, AZ (US); Darko GRUJICIC, Chandler, AZ (US); Bai NIE, Chandler, AZ (US); Tarek A. IBRAHIM, Mesa, AZ (US); Ankur AGRAWAL, Chandler, AZ (US); Sandeep GAAN, Chandler, AZ (US); Ravindranath V. MAHAJAN, Chandler, AZ (US); Aleksandar ALEKSOV, Chandler, AZ (US)

(21) Appl. No.: 17/481,266

(22) Filed: Sep. 21, 2021

(51) Int. Cl. G02B 6/12; H04B 10/70; G02B 6/124; G02B 6/13

(52) U.S. Cl. CPC G02B 6/12004; H04B 10/70; G02B 6/124; G02B 6/13; G02B 2006/12107

(57) ABSTRACT

Embodiments disclosed herein include electronic packages and methods of forming such electronic packages. In an embodiment, an electronic package comprises a first layer, where the first layer comprises glass. In an embodiment, a second layer is over the first layer, where the second layer comprises a mold material. In an embodiment, a first photonics integrated circuit (PIC) is within the second layer. In an embodiment, a second PIC is within the second layer, and a waveguide is in the first layer. In an embodiment, the waveguide optically couples the first PIC to the second PIC.

### TECHNICAL FIELD

Embodiments of the present disclosure relate to electronic packages, and more particularly to electronic packages with photonics integrated circuit (PIC) to PIC optical communication links.

### BACKGROUND

Advancements in electronic packaging are trending towards the use of disaggregated die architectures. That is, a plurality of dies are communicatively coupled together instead of requiring a single larger die, which is harder to manufacture. In existing disaggregated die architectures, the dies are communicatively coupled together by metal conductors fabricated on the package substrate/interposer or by the use of embedded bridges. Embedded bridges provide the ability to have high density routing between the dies.

However, signal loss significantly increases on metal conductors as the signaling frequency increases and the distance between dies increases. Furthermore, conductor routing for die to die communication becomes increasingly complex as more dies/chiplets are added to the package.

### BRIEF DESCRIPTION OF THE DRAWINGS

FIG. 1 is a cross-sectional illustration of an electronic package with disaggregated dies that are coupled together by an optical waveguide, in accordance with an embodiment.

FIG. 2A is a schematic illustration of a first photonics integrated circuit (PIC) that is coupled to a second PIC with a grating coupler, in accordance with an embodiment.

FIG. 2B is a schematic illustration of a first PIC that is coupled to a second PIC with an evanescent coupler, in accordance with an embodiment.

FIG. 2C is a cross-sectional illustration of a first PIC that is coupled to a second PIC with a patterned optical waveguide that accounts for offset die placement, in accordance with an embodiment.

FIG. 3A is a cross-sectional illustration of an electronic package with PICs with the active layer on a top surface of the PICs, in accordance with an embodiment.

FIG. 3B is a cross-sectional illustration of an electronic package with PICs with an active layer on a bottom surface of the PICs, in accordance with an embodiment.

FIG. 3C is a cross-sectional illustration of an electronic package with PICs that are embedded in a mold layer and a glass layer, in accordance with an embodiment.

FIG. 4A is a plan view illustration of an electronic package with a pair of PICs to couple together dies, in accordance with an embodiment.

FIG. 4B is a cross-sectional illustration of an electronic package with a set of four PICs to couple together dies, in accordance with an embodiment.

FIG. 5A is a perspective view illustration of a glass substrate with through glass vias (TGVs), in accordance with an embodiment.

FIG. 5B is a perspective view illustration of the glass substrate after PICs are placed over a top surface of the glass substrate, in accordance with an embodiment.

FIG. 5C is a perspective view illustration of the glass substrate after a mold layer is disposed over a surface of the glass substrate, in accordance with an embodiment.

FIG. 5D is a cross-sectional illustration of the glass substrate after waveguides are formed in the glass substrate, in accordance with an embodiment.

FIG. 5E is a perspective view illustration of the glass substrate after dies are attached over the mold layer, in accordance with an embodiment.

FIG. 6A is a cross-sectional illustration of an electronic package with PICs for coupling together dies, where the PICs are in a mold layer, in accordance with an embodiment.

FIG. 6B is a cross-sectional illustration of an electronic package with PICs for coupling together dies, where the PICs are in buildup layers, in accordance with an embodiment.

FIG. 7A is a schematic illustration of a first PIC that is coupled to a second PIC with a grating coupler, in accordance with an embodiment.

FIG. 7B is a schematic illustration of a first PIC that is coupled to a second PIC with an evanescent coupler, in accordance with an embodiment.

FIG. 7C is a cross-sectional illustration of a first PIC that is coupled to a second PIC with a patterned optical waveguide that accounts for offset die placement, in accordance with an embodiment.

FIG. 8A is a plan view illustration of an electronic package with a pair of PICs to couple together dies, in accordance with an embodiment.

FIG. 8B is a cross-sectional illustration of an electronic package with a set of four PICs to couple together dies, in accordance with an embodiment.

FIG. 9A is a perspective view illustration of a glass substrate with TGVs, in accordance with an embodiment.

FIG. 9B is a perspective view illustration of the glass substrate after PICs are placed over a surface of the glass substrate, in accordance with an embodiment.

FIG. 9C is a perspective view illustration of the glass substrate after a mold layer is disposed over the glass substrate, in accordance with an embodiment.

FIG. 9D is a perspective view illustration of the glass substrate after a waveguide layer is disposed over the mold layer, in accordance with an embodiment.

FIG. 9E is a perspective view illustration of the glass substrate after the waveguide layer is patterned to form a plurality of waveguides, in accordance with an embodiment.

FIG. 9F is a perspective view illustration of the glass substrate after a second mold layer is provided over the waveguides, in accordance with an embodiment.

FIG. 9G is a perspective view illustration of the glass substrate after dies are attached to the second mold layer, in accordance with an embodiment.

FIG. 10 is a cross-sectional illustration of an electronic system with a patch that includes an optical waveguide to connect dies together, in accordance with an embodiment.

FIG. 11 is a schematic of a computing device built in accordance with an embodiment.

### EMBODIMENTS OF THE PRESENT DISCLOSURE

Described herein are electronic packages with photonics integrated circuit (PIC) to PIC optical communication links, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, disaggregated die architectures are increasing in popularity due, in part, to the difficulty of forming large form factor dies. However, the disaggregated die architecture creates issues with signaling between the dies. For example, signal loss significantly increases on metal conductors as the signaling frequency increases and the distance between dies increases. Furthermore, conductor routing for die to die communication becomes increasingly complex as more dies/chiplets are added to the package.

Accordingly, embodiments disclosed herein include photonics integrated circuits (PICs) that use optical waveguides to couple together the disaggregated dies. In an embodiment, PICs are integrated on a glass package to allow for die to die communication. Low signal loss passive glass waveguides can then be utilized for long reaching optical communication between embedded PICs and off-chip components. In addition to enabling high signal frequencies, embodiments disclosed herein can also allow for the utilization of more digital modulation techniques (e.g., four-state quadrature amplitude modulator (QAM4), multiple access, etc.).

In an embodiment, the waveguides are patterned with a laser exposure process. The laser exposure of the glass results in a change in the microstructure of the glass that changes the refractive index. For example, the microstructure may change from an amorphous state to a crystalline state. As such, a channel within the glass substrate can function as an optical waveguide due to the differences in the refractive indexes. The use of a laser writing process also enables patterning that accounts for offset die placement. Such patterning allows for misalignments of the PICs to be accounted for by changing the path of the waveguides.

In yet another embodiment, the optical waveguides are a patterned layer. The optical waveguides may be patterned in a low loss material. For example, the optical waveguides may be formed from a silicon nitride (e.g., Si₃N₄) layer. In an embodiment, the patterning process for such optical waveguides also enable the use of patterning that accounts for misalignment of the PICs.

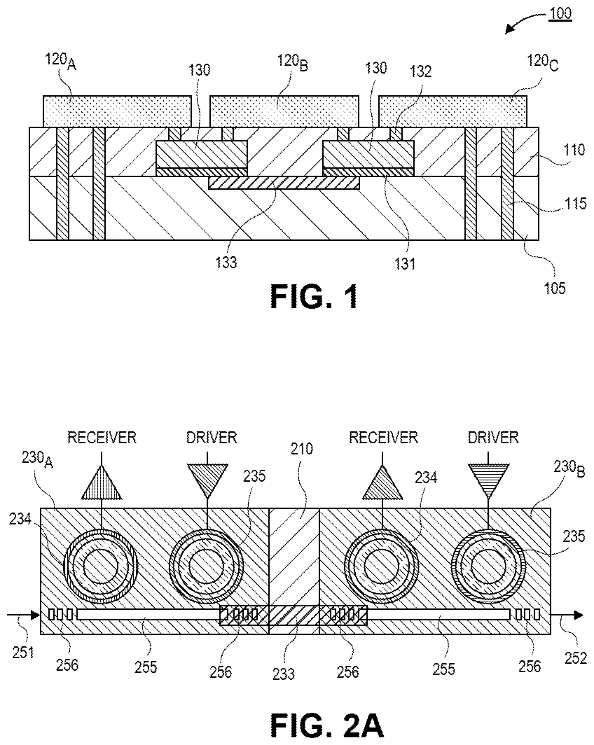

Referring now to FIG. 1, a cross-sectional illustration of an electronic package 100 is shown, in accordance with an embodiment. In an embodiment, the electronic package 100 may be a patch that is coupled to an underlying package substrate (not shown). In an embodiment, the electronic package 100 comprises a core 105. The core 105 may comprise glass. That is, in some embodiments, the core 105 may be referred to as a glass core 105. In an embodiment, a mold layer 110 is provided over the glass core 105. The mold layer 110 may comprise any suitable dielectric material. For example, the mold layer 110 may be an epoxy mold layer 110 or the like.

In an embodiment, a plurality of dies 120 may be provided over the mold layer 110. For example, three dies 120A, 120B, and 120c are shown in FIG. 1. However, it is to be appreciated that more than three dies 120 may be included in the electronic package 100. In an embodiment, the three dies 120 may be electrically and/or optically coupled together by PICs 130. In an embodiment, the PICs 130 comprise photodetectors and/or lasers. The photodetectors allow for incoming optical signals to be converted to an electrical regime, and the laser allows for an outgoing electrical signal to be converted to an optical regime. The photodetectors and the laser may be provided in an active layer 131 of the PICs 130. The PICs 130 may be electrically coupled to the dies 120 by interconnects 132. In an embodiment, through substrate vias (not shown) may couple the active layer 131 to the interconnects 132. In an embodiment, vias 115 may pass through the mold layer 110 and the core 105. The vias 115 may directly couple to the dies 120.

In an embodiment, the PICs 130 may be optically coupled to each other by an optical waveguide 133. The optical waveguide 133 may be embedded in the core 105. In a particular embodiment, the optical waveguide 133 comprises the same material as the core 105. However, the optical waveguide 133 may have a different microstructure than the core 105. The difference in the microstructure allows for there to be a difference in the refractive index between the optical waveguide 133 and the core 105. As such, an optical signal may undergo total internal reflection in order to propagate along the optical waveguide 133.

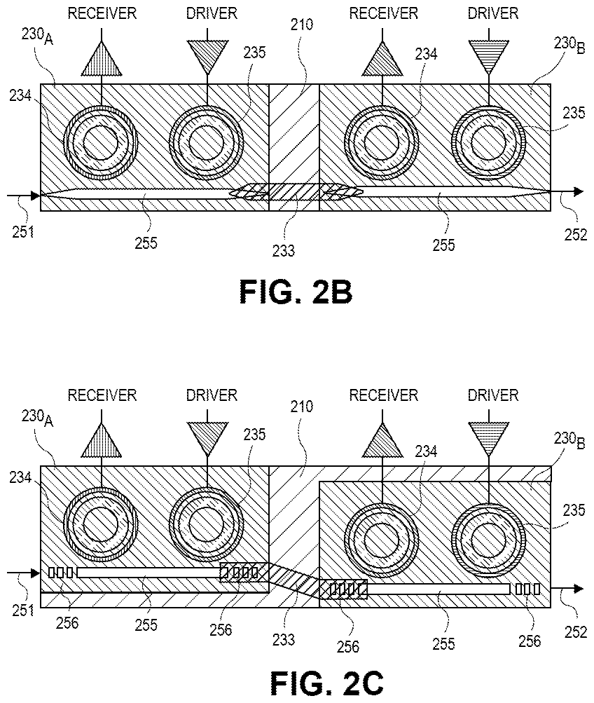

Referring now to FIGS. 2A-2C, schematic illustrations of the coupling between a pair of PICs 230_{A} and 230_{B} are shown, in accordance with various embodiments. In FIG. 2A the coupling between waveguides is a grating coupling, in FIG. 2B the coupling between waveguides is an evanescent/adiabatic coupling, and in FIG. 2C the coupling between waveguides is a grating coupling with a patterned waveguide that accounts for offset die placement.

Referring now to FIG. 2A, a schematic illustration of a pair of PICs 230_{A} and 230_{B} is shown, in accordance with an embodiment. In an embodiment, each PIC 230 comprises a receiver and a driver. The receivers may be coupled to a micro-ring photodetector 234, and the drivers may be coupled to a micro-ring modulator 235. While micro-ring based devices are shown, it is to be appreciated that the PICs 230_{A} and 230_{B} may use any photodetector or modulator architecture.

In an embodiment, each PIC 230_{A} and 230_{B} may include an internal optical waveguide 255. In the illustrated embodiment, ends of the internal optical waveguide 255 have a grating coupler 256. A first end of the PIC 230_{A} may receive an incoming optical signal 251 (e.g., from off chip, a glass waveguide, etc.). A second end of the PIC 230_{A} may be coupled to a waveguide 233. The waveguide 233 may be substantially similar to the waveguide 133 described in greater detail above. While shown as passing through the mold layer 210, the waveguide 233 may also be entirely within the glass core (not shown in FIG. 2A). The waveguide 233 couples the second end of the PIC 230_{A} to the first end of the PIC 230_{B}. For example, the grating coupler 256 allows for an optical signal from the waveguide 233 to be coupled to the internal waveguide 255 of the PIC 230_{B}. In an embodiment, a second end of the PIC 230_{B} may end at an outgoing optical signal 252 (e.g., to off chip, a glass waveguide, etc.).

Referring now to FIG. 2B, a schematic illustration of a pair of PICs 230_{A} and 230_{B} is shown, in accordance with an additional embodiment. In an embodiment, the PICs 230_{A} and 230_{B} may be substantially similar to the PICs 230_{A} and 230_{B} shown in FIG. 2A, with the exception of the coupling mechanism between the optical waveguides. As shown in FIG. 2B, the coupling may include an evanescent or adiabatic coupling architecture. For example, ends of the internal waveguides 255 may be tapered. A similar taper may be provided at the ends of the optical waveguide 233. While two different coupling architectures are shown in FIGS. 2A and 2B, it is to be appreciated that embodiments may include any type of coupling architecture in order to optically couple the first PIC 230_{A} to the second PIC 230_{B}. For example, other architectures, such as butt-coupling, may be used to couple the first PIC 230_{A} to the second PIC 230_{B}.

Referring now to FIG. 2C, a schematic illustration of a pair of PICs 230_{A} and 230_{B} are shown, in accordance with yet another additional embodiment. The PICs 230_{A} and 230_{B} in FIG. 2C may be substantially similar to the PICs 230_{A} and 230_{B} in FIG. 2A, with the exception of the alignment between the PICs 230_{A} and 230_{B} being offset. For example, the second PIC 230_{B} may be attached to the core with a positional offset. As such, a straight optical waveguide 233 would not result in proper coupling between the PIC 230_{A} and the PIC 230_{B}. Instead, an optical waveguide 233 with a pair of turns is used. Such an embodiment is easily enabled through the use of patterning that accounts for offset die placement. Particularly, since the optical waveguide 233 is formed with a laser exposure process, the path of the laser can be changed in order to account for PIC 230 misplacement. Accordingly, placement accuracy for the PICs 230 can be relaxed since the shape of the optical waveguide 233 can be modified.

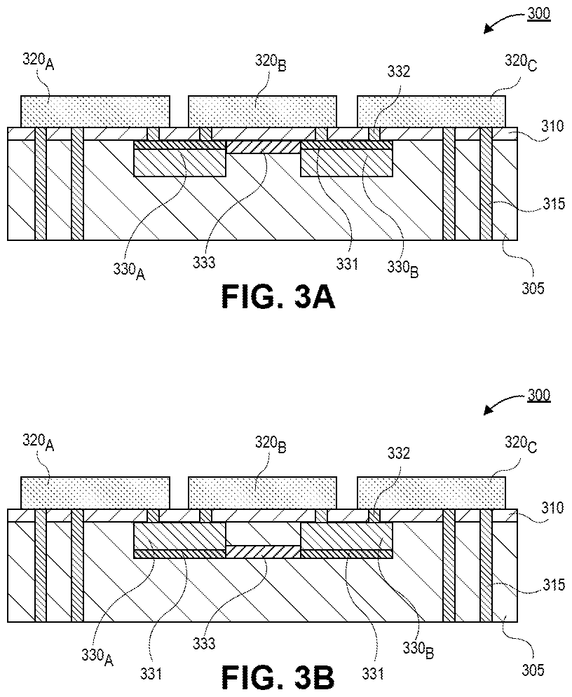

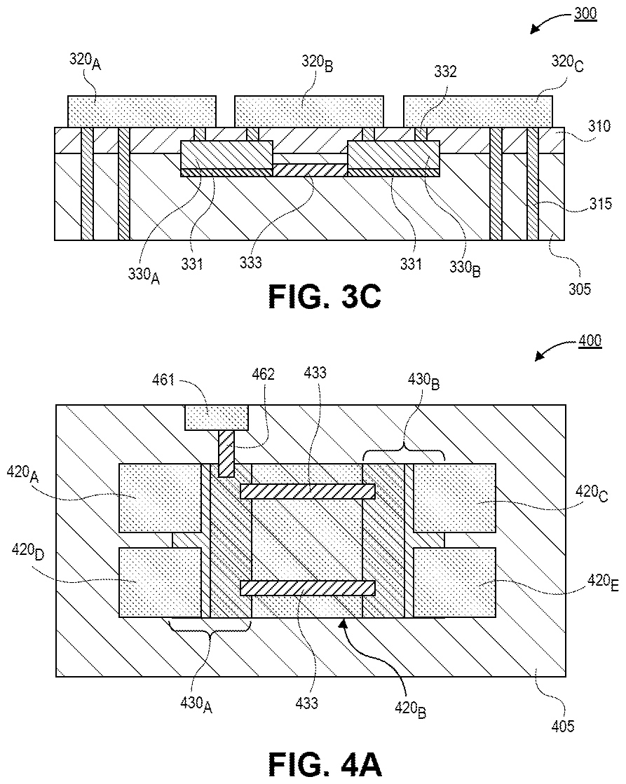

Referring now to FIG. 3A, a cross-sectional illustration of an electronic package 300 is shown, in accordance with an embodiment. In an embodiment, the electronic package 300 comprises a core 305 and a mold layer 310 over the core 305. In an embodiment, the core 305 is a glass core. In an embodiment, a plurality of dies 320A, 320B, and 320c are provided over the mold layer 310. While three dies 320 are shown, it is to be appreciated that any number of dies 320 may be included in embodiments disclosed herein. In an embodiment, vias 315 may couple the dies 320 to the backside of the electronic package 300. For example, the vias 315 may pass through the mold layer 310 and the core 305.

In an embodiment, the electronic package 300 comprises PICs 330_{A} and 330_{B}. The PICs 330_{A} and 330_{B} may be embedded in the core 305. In an embodiment, the active layer 331 of the PICs 330_{A} and 330_{B} may be at a top surface of the PICs 330_{A} and 330_{B}. The PICs 330 may be coupled to one or more dies 320 by interconnects 332 that pass through the mold layer 310. In an embodiment, the PIC 330_{A} is optically coupled to the PIC 330_{B} by an optical waveguide 333. The optical waveguide 333 may be at a top surface of the core 305, between the two active layers 331. In an embodiment, the optical waveguide 333 may include the same material as the core 305. However, the microstructure of the optical waveguide 333 may be different than the microstructure of the core 305. As such, a refractive index of the waveguide 333 is different than a refractive index of the core 305.

Referring now to FIG. 3B, a cross-sectional illustration of an electronic package 300 is shown, in accordance with an additional embodiment. In an embodiment, the electronic package 300 in FIG. 3B may be substantially similar to the electronic package 300 in FIG. 3A, with the exception of the orientation of the PICs 330. Instead of having the active layers 331 on the top surfaces of the PICs 330, the active layers 331 are on the bottom surfaces of the PICs 330. In such an embodiment, the active layers 331 may be coupled to the bottom surface of the PICs 330 by through substrate vias (not shown). Additionally, the optical waveguide 333 may be recessed into the core 305 in order to interface with the active layers 331. As such, the waveguide 333 may be entirely embedded within the core 305 in some embodiments.

Referring now to FIG. 3C, a cross-sectional illustration of an electronic package 300 is shown, in accordance with an additional embodiment. In an embodiment, the electronic package 300 in FIG. 3C may be substantially similar to the electronic package 300 in FIG. 3B, with the exception of the position of the PICs 330. Instead of being fully embedded in the core 305, the PICs 330_{A} and 330_{B} may be partially embedded within the core 305. That is, a top portion of the PICs 330_{A} and 330_{B} may be within the mold layer 310. In an embodiment, the active layers 331 remain within the core 305. That way, the optical waveguide 333 between the PICs 330_{A} and 330_{B} can be entirely embedded within the core 305.

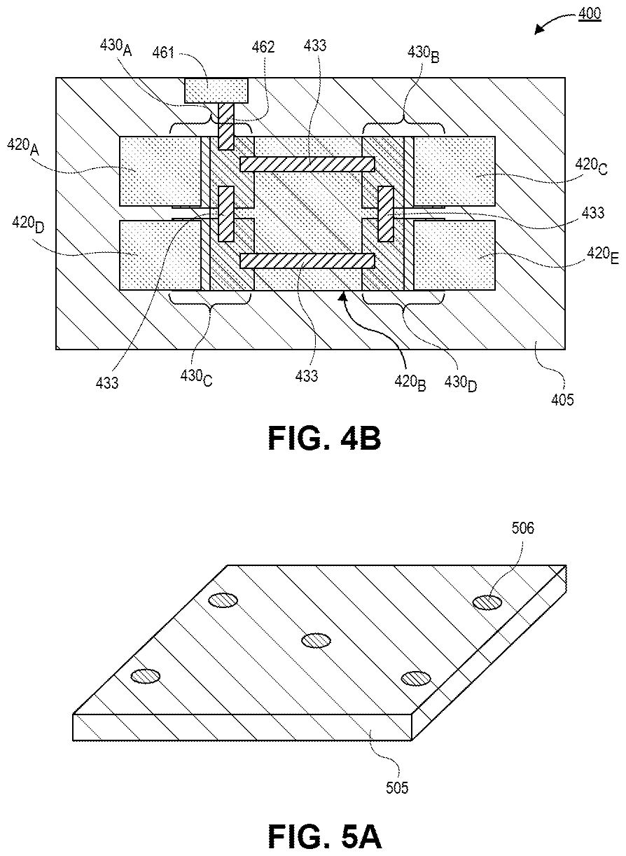

Referring now to FIG. 4A, a plan view illustration of an electronic package 400 is shown, in accordance with an embodiment. In an embodiment, the electronic package 400 comprises a core 405, such as a glass core. In the illustrated embodiment, the mold layer over the glass core 405 is omitted in order to not obscure certain features of the electronic package 400. In an embodiment, the electronic package 400 comprises a pair of PICs 430_{A} and 430_{B}. As shown, a set of five dies 420_{A}-420_{E} are provided over the PICs 430. The die 420B is shown as transparent in order to see the underlying features. In an embodiment, the dies 420_{A}, 420D, and 420B can communicate optically through PIC 430_{A}. Additionally, die 420_{A} can communicate to die 420c through PIC 430_{A}, waveguide 433, and PIC 430_{B}. As such, any of the dies 420_{A}-420_{E} can be optically coupled to each other.

In an embodiment, the first PIC 430_{A} is optically coupled to the second PIC 430_{B} by optical waveguides 433. The optical waveguides 433 may be embedded in the core 405. Similarly, the PICs 430_{A} and 430_{B} may be embedded or at least partially embedded in the core 405. In some embodiments, the optical waveguides 433 are positioned below the PICs 430_{A} and 430_{B}. In other embodiments, the optical waveguides 433 are adjacent to an edge of the PICs 430_{A} and 430_{B}.

In an embodiment, an off-chip fiber connection 461 may also be provided. The off-chip fiber connection 461 may be optically coupled to one or more of the PICs 430 by an optical waveguide 462. That is, embodiments disclosed herein include optical coupling to components outside of the electronic package 400 in addition to optical coupling of components within the electronic package 400.

Referring now to FIG. 4B, a plan view illustration of an electronic package 400 is shown, in accordance with an additional embodiment. In an embodiment, the electronic package 400 in FIG. 4B may be similar to the electronic package 400 in FIG. 4A, with the exception of there being additional PICs 430. For example, four PICs 430_{A}-430D may be included in the electronic package 400. In an embodiment, the four PICs 430 may be optically coupled to each other by optical waveguides 433. While examples of two and four PICs 430 are shown in FIG. 4A and FIG. 4B, it is to be appreciated that embodiments are not limited to such architectures, and embodiments may include any number of PICs 430 to provide a desired level of die disaggregation.

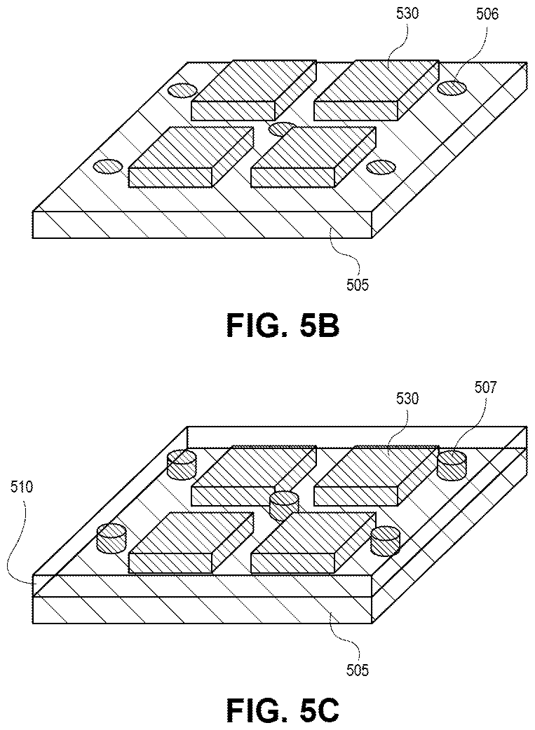

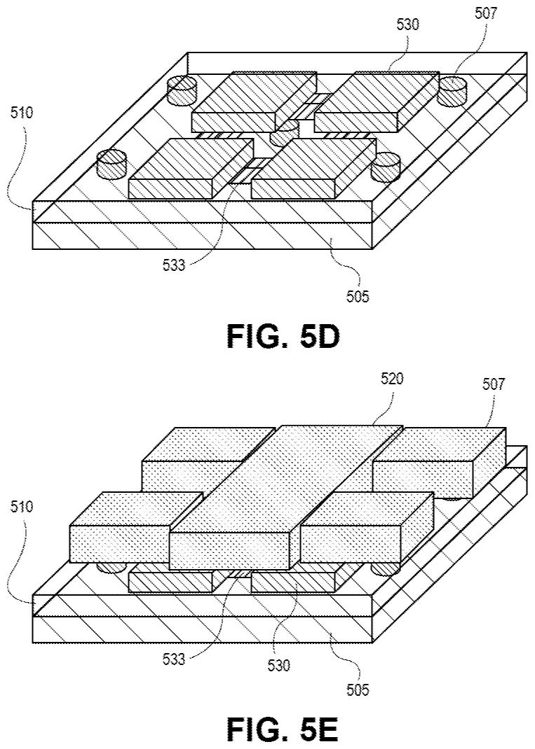

Referring now to FIGS. 5A-5E, a series of perspective view illustrations depicting a process for forming an electronic package is shown, in accordance with an embodiment. In an embodiment, the electronic package formed in FIGS. 5A-5E may be similar to any of the electronic packages described in greater detail above.

Referring now to FIG. 5A, a perspective view illustration of a core 505 is shown, in accordance with an embodiment. In an embodiment, the core 505 may be a glass core. The core 505 may have any suitable thickness. In an embodiment, through core vias 506 may also be provided through a thickness of the core 505. In the illustrated embodiment, only five through core vias 506 are shown for simplicity (i.e., one through core via 506 is for each of the dies added in a subsequent processing operation). However, it is to be appreciated that a plurality of through core vias 506 may be provided for each of the dies.

Referring now to FIG. 5B, a perspective view illustration of the core 505 after a plurality of PICs 530 are attached to the core 505 is shown, in accordance with an embodiment. In an embodiment, the PICs 530 may be substantially similar to the PICs described in greater detail above. For example, the PICs 530 include functionality for converting an optical signal into an electrical signal and/or for converting an electrical signal into an optical signal. In an embodiment, the PICs 530 may be attached to the core with a die attach film (DAF) or the like. In an embodiment, the PICs 530 are positioned between the through core vias 506. That is, the through core vias 506 are positioned outside of the footprint of the PICs 530. In the illustrated embodiment, four PICs 530 are shown. However, it is to be appreciated that any number of PICs 530 may be included (e.g., two or more PICs 530 may be used). In the particular embodiment shown in FIGS. 5A-5E, the PICs 530 may be oriented with an active layer on the bottom of the PICs 530. As such, the active layer can be provided directly on the underlying core 505 so that the active layer can interface with the subsequently formed optical waveguides.

Referring now to FIG. 5C, a perspective view illustration of the core 505 after a mold layer 510 is disposed over the core 505 and around the PICs 530 is shown, in accordance with an embodiment. In an embodiment, the mold layer 510 may be disposed over the core 505 with a molding technique. In other embodiments, the mold layer 510 may be a laminated layer over the core 505 and the PICs 530. The mold layer 510 may comprise any suitable material, such as an epoxy, a buildup film, or the like. In an embodiment, the mold layer 510 may be formed to a thickness so that the mold layer 510 covers a top surface of the PICs 530. In other embodiments, the mold layer 510 may be polished or planarized so that a surface of the mold layer 510 is substantially coplanar with a surface of the PICs 530. In an embodiment, vias 507 may be formed through the mold layer 510. The vias 507 may each land on one of the through core vias 506. In some embodiments, a pad may be provided between the through core vias 506 and the vias 507.

Referring now to FIG. 5D, a perspective view illustration of the core 505 after optical waveguides 533 are formed is shown, in accordance with an embodiment. In an embodiment, the optical waveguides 533 are formed in the core 505. The optical waveguides 533 may pass below the PICs 530. For example, a first end of the optical waveguide 533 may be below a first PIC 530, and a second end of the optical waveguide 533 may be below a second PIC 530. In this way the PICs 530 can be optically coupled together. The optical waveguides 533 may be coupled to the PICs 530 with any coupling architecture, such as, but not limited to, a grating coupler, an evanescent coupler, or an adiabatic coupler.

In an embodiment, the optical waveguides 533 are formed with a laser process. For example, a direct writing process may be used to convert portions of the core 505 into the optical waveguides 533. Laser exposure may change the microstructure of the exposed portions of the core 505. For example, the optical waveguides 533 may have a crystalline microstructure, and the remainder of the core 505 may have an amorphous microstructure. In this way, the refractive index of the optical waveguides 533 is made different than the refractive index of the core 505. Additionally, it is to be appreciated that a direct laser writing process enables the shape of the optical waveguides 533 to be modified in order to account for misalignment of the PICs 530.

Referring now to FIG. 5E, a perspective view illustration of the core 505 after dies 520 are attached to the PICs 530 is shown, in accordance with an embodiment. In the illustrated embodiment, five dies 520 are shown. However, it is to be appreciated that any number of dies 520 may be included in the electronic package. In an embodiment, the dies 520 may be electrically coupled to the PICs 530. For example, interconnects (not shown) similar to interconnects 132 described above may be used to couple the PICs 530 to the dies 520. In an embodiment, the dies 520 may also be coupled to the opposite side of the core 505 by the vias 507 and through core vias 506.

It is to be appreciated that the PICs 530 and the optical waveguides 533 provide enhanced coupling between the dies 520. Instead of relying on electrical connections, optical signals may also be used. The optical signals have lower losses at high frequencies. In addition to enabling high signal frequencies, embodiments disclosed herein can also allow for the utilization of more digital modulation techniques (e.g., QAM4, multiple access, etc.). As such, communication bandwidth can be improved.

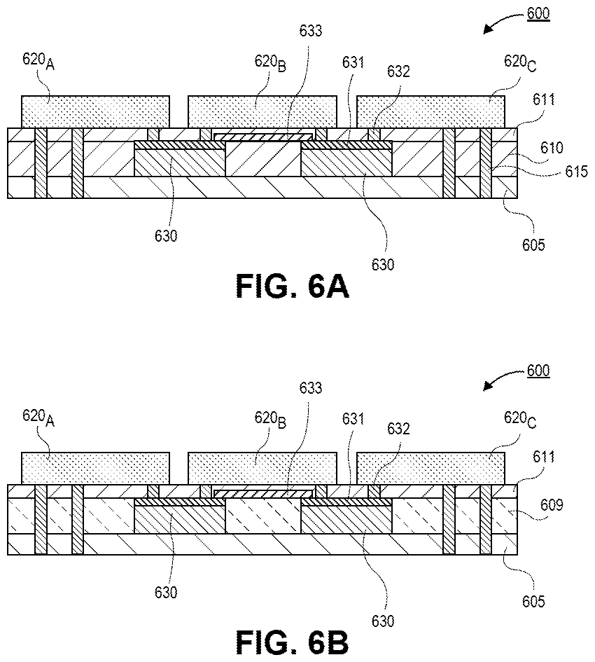

Referring now to FIGS. 6A and 6B, cross-sectional illustrations of electronic packages 600 in accordance with additional embodiments are shown. Whereas the embodiments described above utilize the glass core to form the optical waveguides, embodiments described with respect to FIGS. 6A and 6B utilize a low loss material that is patterned to form the optical waveguides. For example, the low loss material may comprise silicon and nitrogen (e.g., Si₃N₄), or a polymer.

Referring now to FIG. 6A, a cross-sectional illustration of an electronic package 600 is shown, in accordance with an embodiment. In an embodiment, the electronic package 600 comprises a core 605. The core 605 may be a glass core 605 in some embodiments. A mold layer 610 may be provided over the core 605. In an embodiment, the mold layer 610 may be an epoxy or other molding compound. In an embodiment, a plurality of dies 620A-620c may be provided over the top surface of the mold layer 610. In an embodiment, the dies 620A-620c may be coupled together by PICs 630. For example, the dies 620A-620c may be electrically coupled to the PICs 630 by the interconnects 632 through a second mold layer 611. In an embodiment, the dies 620 may also be coupled to the opposite side of the core 605 by vias 615. In an embodiment, the vias 615 pass through the mold layers 610, 611, and the core 605.

In an embodiment, the PICs 630 are embedded in the mold layer 610. An active layer 631 of the PICs 630 may be at a top surface of the PIC 630. In an embodiment, the PICs 630 may be optically coupled to each other by an optical waveguide 633. The optical waveguide 633 may be formed in the second mold layer 611. The second mold layer 611 and the mold layer 610 may have a refractive index that is lower than the refractive index of the optical waveguide 633. In an embodiment, the optical waveguide 633 may be formed from a low loss material. In some embodiments, the optical waveguide 633 comprises silicon and nitrogen. For example, the optical waveguide 633 may comprise Si₃N₄. Though, it is to be appreciated that other low loss materials may also be used for the optical waveguide 633. In an embodiment, the optical waveguide 633 may be provided above a top surface of the PICs 630. In a particular embodiment, the optical waveguide 633 may be in contact with a portion of the active layer 631 of the PIC 630.

Referring now to FIG. 6B, a cross-sectional illustration of an electronic package 600 is shown, in accordance with an additional embodiment. In an embodiment, the electronic package 600 in FIG. 6B may be substantially similar to the electronic package 600 in FIG. 6A, with the exception of the material for the mold layer 610. Instead of a molding material, the embodiment shown in FIG. 6B includes a dielectric layer 609. For example, the dielectric layer 609 may include one or more buildup layers. One or more buildup layers may be laminated over each other to form the dielectric layer 609. In an embodiment, the second mold layer 611 may be a mold material or may also be a dielectric layer, such as a buildup layer. In an embodiment, the dielectric layer 609 and the second mold layer 611 may both have a refractive index that is lower than the refractive index of the optical waveguide 633.

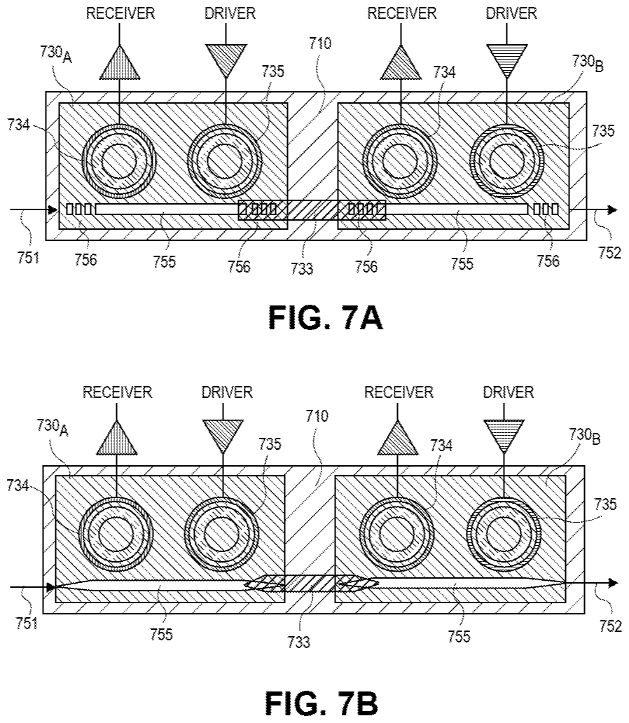

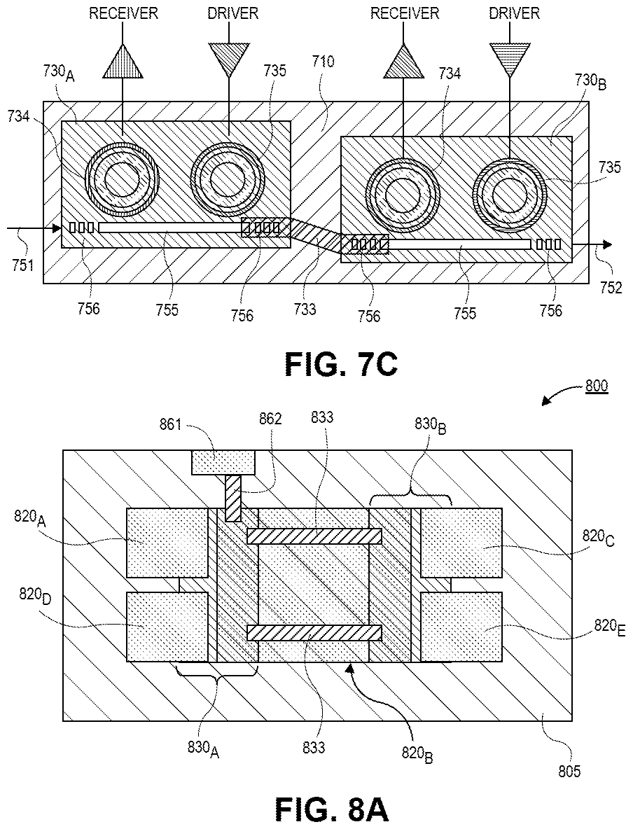

Referring now to FIGS. 7A-7C, schematic illustrations of the coupling between a pair of PICs 730_{A} and 730_{B} are shown, in accordance with various embodiments. In FIG. 7A the coupling between waveguides is a grating coupling, in FIG. 7B the coupling between waveguides is an evanescent/adiabatic coupling, and in FIG. 7C the coupling between waveguides is a grating coupling with a patterned waveguide that accounts for offset die placement.

Referring now to FIG. 7A, a schematic illustration of a pair of PICs 730_{A} and 730_{B} is shown, in accordance with an embodiment. In an embodiment, each PIC 730 comprises a receiver and a driver. The receivers may be coupled to a micro-ring photodetector 734, and the drivers may be coupled to a micro-ring modulator 735. While micro-ring based devices are shown, it is to be appreciated that the PICs 730_{A} and 730_{B} may use any photodetector or modulator architecture.

In an embodiment, each PIC 730_{A} and 730_{B} may include an internal optical waveguide 755. In the illustrated embodiment, ends of the internal optical waveguide 755 have a grating coupler 756. A first end of the PIC 730_{A} may receive an incoming optical signal 751 (e.g., from off chip, a glass waveguide, etc.). A second end of the PIC 730_{A} may be coupled to a waveguide 733. The waveguide 733 may be substantially similar to the waveguide 633 described in greater detail above. That is, the waveguide 733 may be a low loss material such as, but not limited to, Si₃N₄. The waveguide 733 couples the second end of the PIC 730_{A} to the first end of the PIC 730_{B}. For example, the grating coupler 756 allows for an optical signal from the waveguide 733 to be coupled to the internal waveguide 755 of the PIC 730_{B}. In an embodiment, a second end of the PIC 730_{B} may end at an outgoing optical signal 752 (e.g., to off chip, a glass waveguide, etc.).

Referring now to FIG. 7B, a schematic illustration of a pair of PICs 730_{A} and 730_{B} are shown, in accordance with an additional embodiment. In an embodiment, the PICs 730_{A} and 730_{B} may be substantially similar to the PICs 730_{A} and 730_{B} shown in FIG. 7A, with the exception of the coupling mechanism between the optical waveguides. As shown in FIG. 7B, the coupling may include an evanescent or adiabatic coupling architecture. For example, ends of the internal waveguides 755 may be tapered. A similar taper may be provided at the ends of the optical waveguide 733. While two different coupling architectures are shown in FIGS. 7A and 7B, it is to be appreciated that embodiments may include any type of coupling architecture in order to optically couple the first PIC 730_{A} to the second PIC 730_{B}. For example, other architectures, such as butt-coupling may be used to couple the first PIC 730_{A} to the second PIC 730_{B}.

Referring now to FIG. 7C, a schematic illustration of a pair of PICs 730_{A} and 730_{B} are shown, in accordance with yet another additional embodiment. The PICs 730_{A} and 730_{B} in FIG. 7C may be substantially similar to the PICs 730_{A} and 730_{B} in FIG. 7A, with the exception of the alignment between the PICs 730_{A} and 730_{B} being offset. For example, the second PIC 730_{B} may be attached to the core with a positional offset. As such, a straight optical waveguide 733 would not result in proper coupling between the PIC 730_{A} and the PIC 730_{B}. Instead, an optical waveguide 733 with a pair of turns is used. Such an embodiment is easily enabled through the use of patterning that accounts for offset die placement. Particularly, the path of the direct write laser can be altered in order to account for PIC 730 misplacement. Accordingly, placement accuracy for the PICs 730 can be relaxed since the shape of the optical waveguide 733 can be modified.

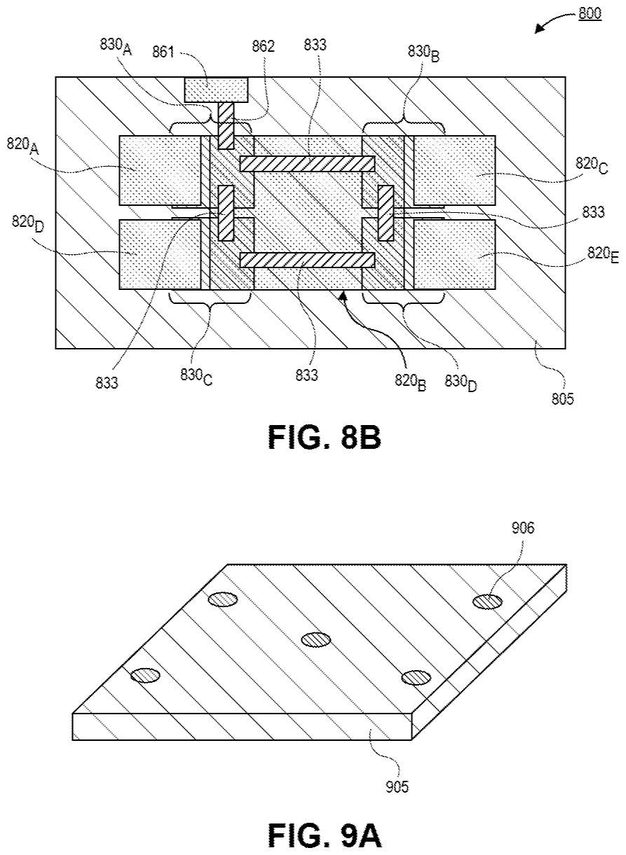

Referring now to FIG. 8A, a plan view illustration of an electronic package 800 is shown, in accordance with an embodiment. In an embodiment, the electronic package 800 comprises a core 805, such as a glass core. In the illustrated embodiment, the mold layer or dielectric layer over the glass core 805 is omitted in order to not obscure certain features of the electronic package 800. In an embodiment, the electronic package 800 comprises a pair of PICs 830_{A} and 830_{B}. As shown, a set of five dies 820_{A}-820_{E} are provided over the PICs 830. The die 820_{B} is shown as transparent in order to see the underlying features.

In an embodiment, the first PIC 830_{A} is optically coupled to the second PIC 830_{B} by optical waveguides 833. The optical waveguides 833 may be embedded in the mold layer above the PICs 830. Similarly, the PICs 830_{A} and 830_{B} may be embedded in a mold layer or dielectric layer above the core 805. In some embodiments, the optical waveguides 833 are positioned above the PICs 830_{A} and 830_{B}. In other embodiments, the optical waveguides 833 are adjacent to an edge of the PICs 830_{A} and 830_{B}.

In an embodiment, an off-chip fiber connection 861 may also be provided. The off-chip fiber connection 861 may be optically coupled to one or more of the PICs 830 by an optical waveguide 862. That is, embodiments disclosed herein include optical coupling to components outside of the electronic package 800 in addition to optical coupling of components within the electronic package 800.

Referring now to FIG. 8B, a plan view illustration of an electronic package 800 is shown, in accordance with an additional embodiment. In an embodiment, the electronic package 800 in FIG. 8B may be similar to the electronic package 800 in FIG. 8A, with the exception of there being additional PICs 830. For example, four PICs 830_{A}-830_{D} may be included in the electronic package 800. In an embodiment, the four PICs 830 may be optically coupled to each other by optical waveguides 833. While examples of two and four PICs 830 are shown in FIG. 8A and FIG. 8B, it is to be appreciated that embodiments are not limited to such architectures, and embodiments may include any number of PICs 830 to provide a desired level of die disaggregation.

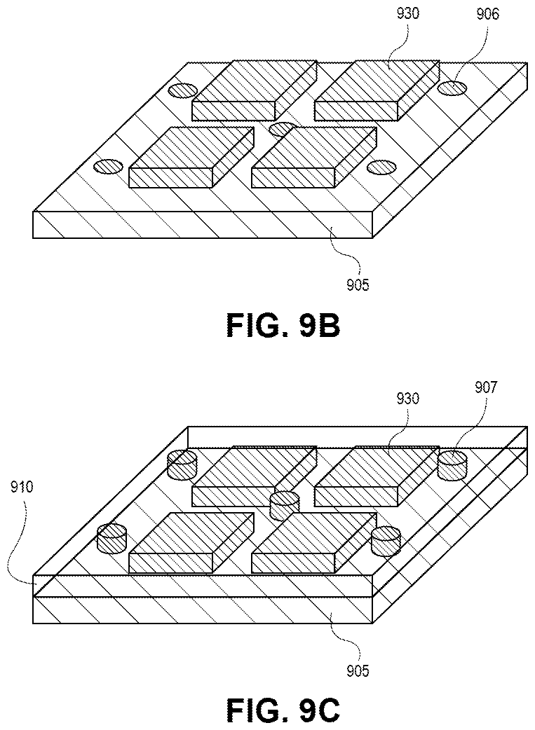

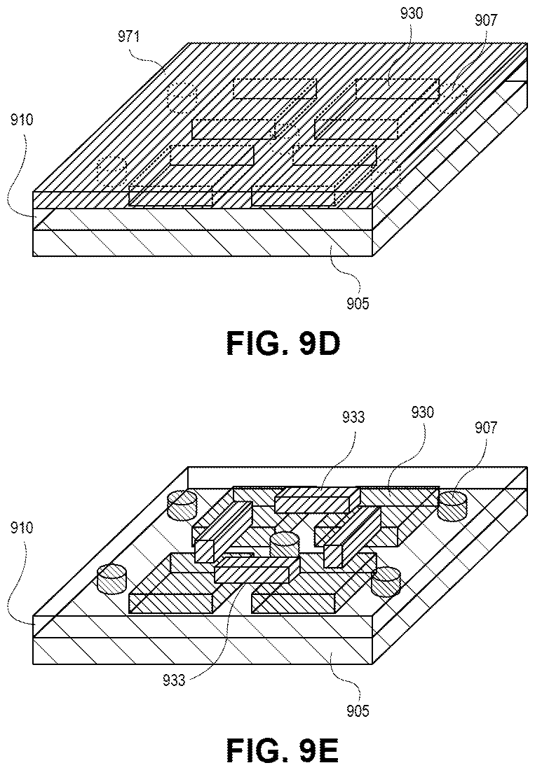

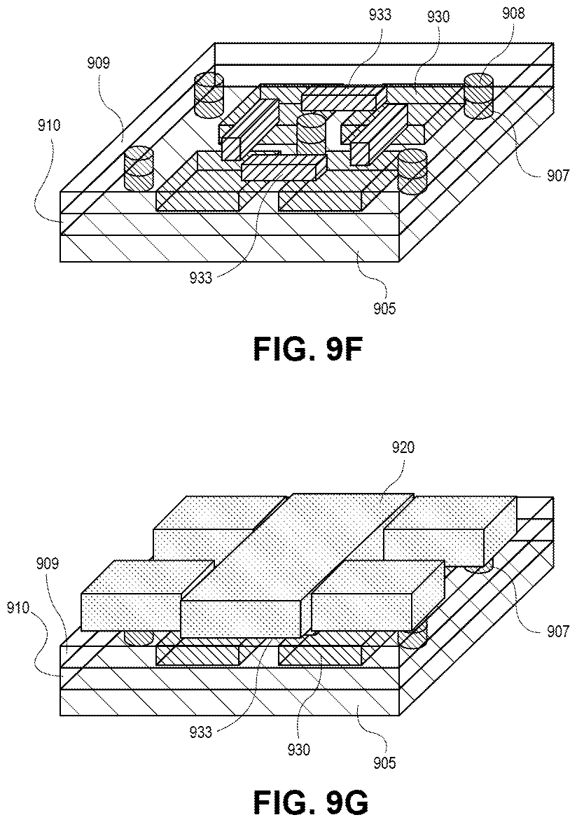

Referring now to FIGS. 9A-9G, a series of perspective view illustrations depicting a process for forming an electronic package is shown, in accordance with an embodiment. In an embodiment, the electronic package formed in FIGS. 9A-9G may be similar to any of the electronic packages described in greater detail above.

Referring now to FIG. 9A, a perspective view illustration of a core 905 is shown, in accordance with an embodiment. In an embodiment, the core 905 may be a glass core. The core 905 may have any suitable thickness. In an embodiment, through core vias 906 may also be provided through a thickness of the core 905. In the illustrated embodiment, only five through core vias 906 are shown for simplicity (i.e., one through core via 906 is for each of the dies added in a subsequent processing operation). However, it is to be appreciated that a plurality of through core vias 906 may be provided for each of the dies.

Referring now to FIG. 9B, a perspective view illustration of the core 905 after a plurality of PICs 930 are attached to the core 905 is shown, in accordance with an embodiment. In an embodiment, the PICs 930 may be substantially similar to the PICs described in greater detail above. For example, the PICs 930 include functionality for converting an optical signal into an electrical signal and/or for converting an electrical signal into an optical signal. In an embodiment, the PICs 930 may be attached to the core with a DAF or the like. In an embodiment, the PICs 930 are positioned between the through core vias 906. That is, the through core vias 906 are positioned outside of the footprint of the PICs 930. In the illustrated embodiment, four PICs 930 are shown. However, it is to be appreciated that any number of PICs 930 may be included (e.g., two or more PICs 930 may be used). In the particular embodiment shown in FIGS. 9A-9G, the PICs 930 may be oriented with an active layer on the top of the PICs 930. As such, the active layer can interface with the subsequently formed optical waveguides.

Referring now to FIG. 9C, a perspective view illustration of the core 905 after a mold layer 910 is disposed over the core 905 and around the PICs 930 is shown, in accordance with an embodiment. In an embodiment, the mold layer 910 may be disposed over the core 905 with a molding technique. In other embodiments, the mold layer 910 may be a laminated layer or layers over the core 905 and the PICs 930. The mold layer 910 may comprise any suitable material, such as an epoxy, a buildup film, or the like. In an embodiment, the mold layer 910 may be polished or planarized so that a surface of the mold layer 910 is substantially coplanar with a surface of the PICs 930. In an embodiment, vias 907 may be formed through the mold layer 910. The vias 907 may each land on one of the through core vias 906. In some embodiments, a pad may be provided between the through core vias 906 and the vias 907.

Referring now to FIG. 9D, a perspective view illustration of the core 905 after a waveguide layer 971 is disposed over the mold layer 910 is shown, in accordance with an embodiment. In an embodiment, the waveguide layer 971 may be blanket deposited over mold layer 910 with a low temperature deposition process. In an embodiment, the waveguide layer 971 comprises a low loss material. The waveguide layer 971 is a material with an refractive index that is greater than the refractive index of the mold layer 910. For example, the waveguide layer 971 may comprise silicon and nitrogen (e.g., Si₃N₄).

Referring now to FIG. 9E, a perspective view illustration of the core 905 after the waveguides 933 are patterned is shown, in accordance with an embodiment. In an embodiment, the patterning process may be a patterning process that accounts for offset die placement. For example, a resist may be deposited over the waveguide layer 971. A laser direct imaging process may then be used to expose the resist at locations where the waveguide 933 is desired. Since the exposure is done with a laser direct imaging process, the waveguides 933 may be positioned and/or shaped to account for any offsets in the placement of the PICs 930. The resist is then developed. After the pattern is made in the resist, the pattern can be transferred into the waveguide layer 971 with an etching process. The resist can then be stripped to leave behind the optical waveguides 933. While an embodiment with laser direct imaging is described, it is to be appreciated that standard lithography (e.g., using a mask to expose certain regions) may also be used in some embodiments.

Referring now to FIG. 9F, a perspective view illustration of the core 905 after a second mold layer 909 is provided above the optical waveguides 933 is shown, in accordance with an embodiment. In an embodiment, the second mold layer 909 may be a material with a refractive index that is lower than a refractive index of the optical waveguides 933. In an embodiment, the second mold layer 909 may be the same material as the mold layer 910. In an embodiment, vias 908 are formed through the second mold layer 909. The vias 908 may land on the underlying vias 907 through the mold layer 910. In some embodiments a pad may be provided between the vias 908 and the vias 907.

Referring now to FIG. 9G, a perspective view illustration of the core 905 after dies 920 are attached to the PICs 930 is shown, in accordance with an embodiment. In the illustrated embodiment, five dies 920 are shown. However, it is to be appreciated that any number of dies 920 may be included in the electronic package. In an embodiment, the dies 920 may be electrically coupled to the PICs 930. For example, interconnects (not shown) similar to interconnects 632 described above may be used to couple the PICs 930 to the dies 920. In an embodiment, the dies 920 may also be coupled to the opposite side of the core 905 by the vias 908, 907 and through core vias 906.

It is to be appreciated that the PICs 930 and the optical waveguides 933 provide enhanced coupling between the dies 920. Instead of relying on electrical connections, optical signals may also be used. The optical signals have lower losses at high frequencies. In addition to enabling high signal frequencies, embodiments disclosed herein can also allow for the utilization of more digital modulation techniques (e.g., QAM4, multiple access, etc.). As such, communication bandwidth can be improved.

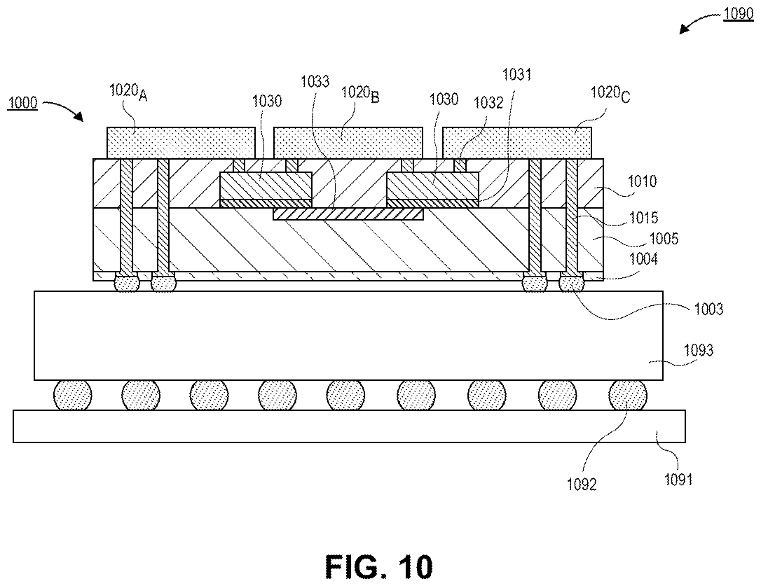

Referring now to FIG. 10, a cross-sectional illustration of an electronic system 1090 is shown, in accordance with an embodiment. In an embodiment, the electronic system 1090 comprises a board 1091, such as a printed circuit board (PCB). In an embodiment, a package substrate 1093 may be coupled to the board 1091 with second level interconnects (SLIs) 1092. While solder balls are shown as the SLIs 1092, it is to be appreciated that any SLI architecture (e.g., sockets, etc.) may be used. In an embodiment, the package substrate 1093 may be any typical package substrate. For example, the package substrate 1093 may include conductive routing and the like. In some embodiments, the package substrate 1093 may be a coreless package substrate or a cored package substrate.

In an embodiment, electronic package 1000 may be coupled to the package substrate 1093 by mid-level interconnects (MLIs) 1003. The MLIs 1003 may pass through a solder resist 1004 on the bottom of the core 1005. In other embodiments, a redistribution layer or the like may be provided below the core 1005. In an embodiment, the MLIs 1003 are coupled to the dies 1020_{A}-1020_{C} by vias 1015 that pass through the core 1005 and the mold layer 1010. In an embodiment, PICs 1030 may be embedded in the mold layer 1010. The PICs 1030 may be optically coupled together by an optical waveguide 1033 that is embedded in the core 1005. In an embodiment, the PICs 1030 may be electrically coupled to the dies 1020_{A}-1020_{C} by interconnects 1032 through the mold layer 1010. In an additional embodiment, a solder resist layer, one or more redistribution layers, and/or any other routing may be provided between the mold layer 1010 and the dies 1020.

In the illustrated embodiment, the electronic package 1000 is similar to the electronic package 100 shown in FIG. 1. However, it is to be appreciated that the electronic system 1090 may include electronic packages similar to any of the embodiments described herein.

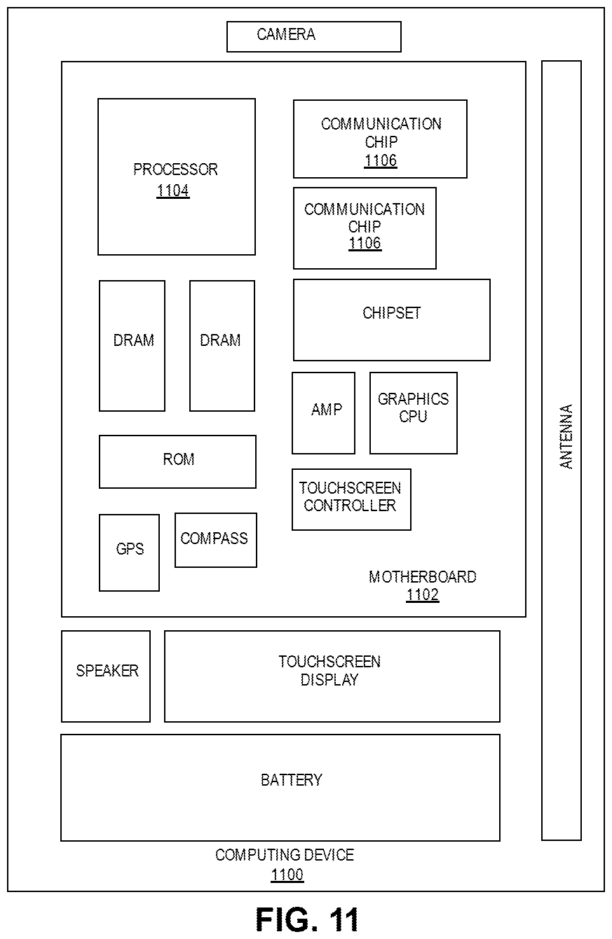

FIG. 11 illustrates a computing device 1100 in accordance with one implementation of the invention. The computing device 1100 houses a board 1102. The board 1102 may include a number of components, including but not limited to a processor 1104 and at least one communication chip 1106. The processor 1104 is physically and electrically coupled to the board 1102. In some implementations the at least one communication chip 1106 is also physically and electrically coupled to the board 1102. In further implementations, the communication chip 1106 is part of the processor 1104.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1106 enables wireless communications for the transfer of data to and from the computing device 1100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1106 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1100 may include a plurality of communication chips 1106. For instance, a first communication chip 1106 may be dedicated to shorter range wireless communications such as Wi-Fi and Bluetooth and a second communication chip 1106 may be dedicated to longer range wireless communications such as GPS, EDGE, GPRS, CDMA, WiMAX, LTE, Ev-DO, and others.

The processor 1104 of the computing device 1100 includes an integrated circuit die packaged within the processor 1104. In some implementations of the invention, the integrated circuit die of the processor may be part of an electronic package that comprises a plurality of PICs that are optically coupled together by optical waveguides, in accordance with embodiments described herein. The term “processor” may refer to any device or portion of a device that processes electronic data from registers and/or memory to transform that electronic data into other electronic data that may be stored in registers and/or memory.

The communication chip 1106 also includes an integrated circuit die packaged within the communication chip 1106. In accordance with another implementation of the invention, the integrated circuit die of the communication chip may be part of an electronic package that comprises a plurality of PICs that are optically coupled together by optical waveguides, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: an electronic package, comprising: a first layer, wherein the first layer comprises glass; a second layer over the first layer, wherein the second layer comprises a mold material; a first photonics integrated circuit (PIC) within the second layer; a second PIC within the second layer; and a waveguide in the first layer, wherein the waveguide optically couples the first PIC to the second PIC.

Example 2: the electronic package of Example 1, wherein the first PIC and the second PIC are optically coupled to the waveguide by grating couplers.

Example 3: the electronic package of Example 1, wherein the first PIC and the second PIC are optically coupled to the waveguide by evanescent couplers.

Example 4: the electronic package of Examples 1-3, further comprising: a first die over the second layer, wherein the first die is electrically coupled to the first PIC and the second PIC.

Example 5: the electronic package of Example 4, further comprising: a second die over the second layer, wherein the second die is coupled to the first PIC; and a third die over the second layer, wherein the third die is coupled to the second PIC.

Example 6: electronic package of Example 5, further comprising: a first via coupled to the second die, wherein the first via passes through the first layer and the second layer; and a second via coupled to the third die, wherein the second via passes through the first layer and the second layer.

Example 7: the electronic package of Examples 1-6, wherein the first PIC and the second PIC extend into the first layer.

Example 8: the electronic package of Examples 1-7, wherein the waveguide comprises the same material as the first layer, wherein the waveguide has a different microstructure than the first layer.

Example 9: the electronic package of Examples 1-8, wherein the first PIC and the second PIC are in contact with a top surface of the first layer.

Example 10: the electronic package of Example 9, wherein an active layer of the first PIC and an active layer of the second PIC are in contact with the top surface of the first layer.

Example 11: the electronic package of Example 10, further comprising: through substrate vias through the first PIC and the second PIC.

Example 12: the electronic package of Examples 1-11, wherein the waveguide extends below the first PIC and below the second PIC.

Example 13: an electronic package, comprising: a first layer, wherein the first layer comprises a glass; a second layer over the first layer, wherein the second layer comprises a mold material; a first photonics integrated circuit (PIC) embedded in the first layer, the second layer, or the first layer and the second layer; a second PIC embedded in the first layer, the second layer, or the first layer and the second layer; and a waveguide in the first layer, wherein the waveguide optically couples the first PIC to the second PIC.

Example 14: the electronic package of Example 13, wherein the first PIC and the second PIC are in the first layer, wherein an active layer of the first PIC is at a top surface of the first PIC, and wherein an active layer of the second PIC is at a top surface of the second PIC.

Example 15: the electronic package of Example 14, wherein the waveguide is at a top surface of the first layer.

Example 16: the electronic package of Examples 13-15, wherein the first PIC and the second PIC are in the first layer, wherein an active layer of the first PIC is at a bottom surface of the first PIC, and wherein an active layer of the second PIC is at a bottom surface of the second PIC.

Example 17: the electronic package of Example 16, wherein the waveguide is embedded in the first layer.

Example 18: the electronic package of Examples 13-17, wherein the first PIC and the second PIC are in the first layer and the second layer, wherein an active layer of the first PIC is at a bottom surface of the first PIC, and wherein an active layer of the second PIC is at a bottom surface of the second PIC.

Example 19: a method of forming an electronic package, comprising: forming vias through a first layer, wherein the first layer comprises glass; attaching a plurality of photonics integrated circuits (PICs) to the first layer; disposing a second layer over the first layer and the plurality of PICs; forming optical waveguides in the first layer, wherein the optical waveguides optically couple the PICs together; and disposing dies over the second layer.

Example 20: the method of Example 19, wherein forming the optical waveguides comprises exposing the first layer to a laser.

Example 21: the method of Example 20, wherein the optical waveguide formation is patterned with a process to account for misplacement of the plurality of PICs.

Example 22: the method of Examples 19-21, wherein the second layer is a mold layer.

Example 23: an electronic system, comprising: a board; a package substrate coupled to the board; and a patch coupled to the package substrate, wherein the patch comprises: a first layer, wherein the first layer comprises glass; a second layer over the first layer, wherein the second layer comprises a mold material; a first photonics integrated circuit (PIC) within the second layer; a second PIC within the second layer; and a waveguide in the first layer, wherein the waveguide optically couples the first PIC to the second PIC; and a die coupled to the patch.

Example 24: the electronic system of Example 23, wherein the first PIC and the second PIC extend into the first layer.

Example 25: the electronic package of Example 23 or Example 24, wherein the waveguide comprises the same material as the first layer, wherein the waveguide has a different microstructure than the first layer.

Example 26: an electronic package, comprising: a first layer, wherein the first layer comprises glass; a second layer over the first layer, wherein the second layer comprises a dielectric material; a first photonics integrated circuit (PIC) embedded in the second layer; a second PIC embedded in the second layer; a third layer over the second layer; and a waveguide in the third layer, wherein the waveguide optically couples the first PIC to the second PIC.

Example 27: the electronic package of Example 26, wherein the waveguide comprises silicon and nitrogen.

Example 28: the electronic package of Example 26 or Example 27, wherein the second layer is a plurality of buildup layers.

Example 29: the electronic package of Examples 26-28, wherein the second layer is a mold material.

Example 30: the electronic package of Examples 26-29, wherein the third layer is a mold material.

Example 31: the electronic package of Examples 26-30, wherein the waveguide is coupled to the first PIC and the second PIC by a grating coupler.

Example 32: the electronic package of Examples 26-31, wherein the waveguide is coupled to the first PIC and the second PIC by evanescent coupling.

Example 33: the electronic package of Examples 26-32, wherein the waveguide extends over a top surface of the first PIC and the second PIC.

Example 34: the electronic package of Example 33, wherein an active layer of the first PIC is at a top of the first PIC, and wherein an active layer of the second PIC is at a top of the second PIC.

Example 35: the electronic package of Examples 26-34, further comprising: a die over the third layer, wherein the die is coupled to the first PIC and the second PIC.

Example 36: the electronic package of Example 35, further comprising: a second die over the third layer, wherein the second die is coupled to the first PIC; and a third die over the third layer, wherein the third die is coupled to the second PIC.

Example 37: an electronic package, comprising: a first photonics integrated circuit (PIC); a second PIC; a waveguide between the first PIC and the second PIC; a first die, wherein the first die is electrically coupled to the first PIC; a second die wherein the second die is electrically coupled to the first PIC and the second PIC; and a third die, wherein the third die is electrically coupled to the second PIC.

Example 38: the electronic package of Example 37, wherein the first PIC and the second PIC are embedded in a mold layer.

Example 39: the electronic package of Example 38, further comprising: a glass layer under the mold layer.

Example 40: the electronic package of Example 38, wherein the waveguide is above the mold layer.

Example 41: the electronic package of Examples 37-40, wherein the waveguide comprises silicon and nitrogen.

Example 42: the electronic package of Examples 37-41, wherein the first die is electrically coupled to the second die through the first PIC, and wherein the second die is electrically coupled to the third die through the second PIC.

Example 43: the electronic package of Example 42, wherein the first die is optically coupled to the third die through the first PIC and the second PIC.

Example 44: a method of forming an electronic package, comprising: attaching a plurality of photonics integrated circuits (PICs) to a glass substrate; forming a first mold layer over the glass substrate and the plurality of PICs; depositing a layer comprising silicon and nitrogen over the mold layer; patterning the layer to form a plurality of waveguides, wherein the waveguides optically couple the plurality of PICs together; forming a second mold layer over the waveguides; and attaching a plurality of dies to the second mold layer.

Example 45: the method of Example 44, wherein patterning the layer to form the plurality of waveguides includes patterning to account for misalignment of the plurality of PICs.

Example 46: the method of Example 44 or Example 45, further comprising vias through the glass substrate, wherein the vias are electrically coupled to the plurality of dies.

Example 47: the method of Examples 44-46, wherein the first mold layer and the second mold layer comprise a low refractive index material.

Example 48: an electronic system, comprising: a board; a package substrate coupled to the board; a patch coupled to the package substrate, wherein the patch comprises: a first layer, wherein the first layer comprises glass; a second layer over the first layer, wherein the second layer comprises a dielectric material; a first photonics integrated circuit (PIC) embedded in the second layer; a second PIC embedded in the second layer; a third layer over the second layer; and a waveguide in the third layer, wherein the waveguide optically couples the first PIC to the second PIC.

Example 49: the electronic system of Example 48, wherein the waveguide comprises silicon and nitrogen.

Example 50: the electronic system of Example 48 or Example 49, wherein the second layer and the third layer comprise a material with a low refractive index.

What is claimed is:

1. An electronic package, comprising:
a first layer, wherein the first layer comprises glass;
a second layer over the first layer, wherein the second layer comprises a mold material;
a first photonics integrated circuit (PIC) within the second layer;
a second PIC within the second layer; and
a waveguide in the first layer, wherein the waveguide optically couples the first PIC to the second PIC.

2. The electronic package of claim 1, wherein the first PIC and the second PIC are optically coupled to the waveguide by grating couplers.

3. The electronic package of claim 1, wherein the first PIC and the second PIC are optically coupled to the waveguide by evanescent couplers.

4. The electronic package of claim 1, further comprising:
a first die over the second layer, wherein the first die is electrically coupled to the first PIC and the second PIC.

5. The electronic package of claim 4, further comprising:
a second die over the second layer, wherein the second die is coupled to the first PIC; and
a third die over the second layer, wherein the third die is coupled to the second PIC.

6. The electronic package of claim 5, further comprising:
a first via coupled to the second die, wherein the first via passes through the first layer and the second layer; and
a second via coupled to the third die, wherein the second via passes through the first layer and the second layer.

7. The electronic package of claim 1, wherein the first PIC and the second PIC extend into the first layer.

8. The electronic package of claim 1, wherein the waveguide comprises the same material as the first layer, wherein the waveguide has a different microstructure than the first layer.

9. The electronic package of claim 1, wherein the first PIC and the second PIC are in contact with a top surface of the first layer.

10. The electronic package of claim 9, wherein an active layer of the first PIC and an active layer of the second PIC are in contact with the top surface of the first layer.

11. The electronic package of claim 10, further comprising:
through substrate vias through the first PIC and the second PIC.

12. The electronic package of claim 1, wherein the waveguide extends below the first PIC and below the second PIC.

13. An electronic package, comprising:
a first layer, wherein the first layer comprises a glass;
a second layer over the first layer, wherein the second layer comprises a mold material;
a first photonics integrated circuit (PIC) embedded in the first layer, the second layer, or the first layer and the second layer;
a second PIC embedded in the first layer, the second layer, or the first layer and the second layer; and
a waveguide in the first layer, wherein the waveguide optically couples the first PIC to the second PIC.

14. The electronic package of claim 13, wherein the first PIC and the second PIC are in the first layer, wherein an active layer of the first PIC is at a top surface of the first PIC, and wherein an active layer of the second PIC is at a top surface of the second PIC.

15. The electronic package of claim 14, wherein the waveguide is at a top surface of the first layer.

16. The electronic package of claim 13, wherein the first PIC and the second PIC are in the first layer, wherein an active layer of the first PIC is at a bottom surface of the first PIC, and wherein an active layer of the second PIC is at a bottom surface of the second PIC.

17. The electronic package of claim 16, wherein the waveguide is embedded in the first layer.

18. The electronic package of claim 13, wherein the first PIC and the second PIC are in the first layer and the second layer, wherein an active layer of the first PIC is at a bottom surface of the first PIC, and wherein an active layer of the second PIC is at a bottom surface of the second PIC.

19. A method of forming an electronic package, comprising:
forming vias through a first layer, wherein the first layer comprises glass;
attaching a plurality of photonics integrated circuits (PICs) to the first layer;
disposing a second layer over the first layer and the plurality of PICs;
forming optical waveguides in the first layer, wherein the optical waveguides optically couple the PICs together; and
disposing dies over the second layer.

20. The method of claim 19, wherein forming the optical waveguides comprises exposing the first layer to a laser.

21. The method of claim 20, wherein the optical waveguide formation is patterned with a process to account for misplacement of the plurality of PICs.

22. The method of claim 19, wherein the second layer is a mold layer.

23. An electronic system, comprising:
a board;
a package substrate coupled to the board; and
a patch coupled to the package substrate, wherein the patch comprises:
a first layer, wherein the first layer comprises glass;
a second layer over the first layer, wherein the second layer comprises a mold material;
a first photonics integrated circuit (PIC) within the second layer;
a second PIC within the second layer; and
a waveguide in the first layer, wherein the waveguide optically couples the first PIC to the second PIC; and
a die coupled to the patch.

24. The electronic system of claim 23, wherein the first PIC and the second PIC extend into the first layer.

25. The electronic package of claim 23, wherein the waveguide comprises the same material as the first layer, wherein the waveguide has a different microstructure than the first layer.
